(19) United States
(12) Patent Application Publication
(10) Pub. No.: US 2016/0113303 A1
(43) Pub. Date: Apr. 28, 2016

(54) Workstation with a Heat Sink for the Iso-thermal, Beta Crystal Stabilization of Chocolate

(71) Applicants: Christophe Toury, Astoria, NY (US); Peter Moustakerski, New York, NY (US); Dennis Teets, Grantville, PA (US)

(72) Inventors: Christophe Toury, Astoria, NY (US); Peter Moustakerski, New York, NY (US); Dennis Teets, Grantville, PA (US)

(21) Appl. No.: 14/923,797

(22) Filed: Oct. 27, 2015

Related U.S. Application Data
(60) Provisional application No. 62/069,193, filed on Oct. 27, 2014.

(51) Int. Cl. A23G 1/04

(52) U.S. Cl. CPC A23G 1/04

(57) ABSTRACT

A Workstation with a Heat Sink for the Iso-thermal, Beta Crystal Stabilization of Tempered Chocolate designed to maintain the temperature of chocolate above 85° F. for up to 60 minutes and within 1° F. degree of its temperature at removal from the tempering equipment for 15 minutes. The heat sink is designed to hold up to four types of chocolate at a time in a useable tempered state by providing a homogenous temperature environment for the bowl base. In conjunction with the heated base, a cover is provided to prevent the contact of the chocolate's surface with the 70° F. to 80° F. room air when the chocolate is not being used. This allows white, milk, and dark chocolates which have different final tempering temperatures to be housed in the same heat sink.

### FEDERALLY SPONSORED RESEARCH

Not Applicable

### SEQUENCE LISTING OR PROGRAM

Not Applicable

### CROSS REFERENCE TO RELATED APPLICATIONS

This application claims priority from U.S. patent application Ser. No. 62/069,193, entitled “A Workstation with a Heat Sink for the Iso-thermal, Beta Crystal Stabilization of Chocolate”, filed on 27 Oct. 2014. The benefit under 35 USC §119(e) of the United States provisional application is hereby claimed, and the aforementioned application is hereby incorporated herein by reference.

### TECHNICAL FIELD OF THE INVENTION

The present invention relates generally to an apparatus for the non-cooking and heat treatment of food. More specifically, the present invention relates to an apparatus for controllably holding a chocolate in proper temper in a retail entertainment setting with chocolate.

### BACKGROUND OF THE INVENTION

Cocoa butter is used in creating high end chocolate confections primary because it gives a quick flavor release and creamy in-the-mouth texture. The reason for this is that almost all of the fat crystals are melted at 95° F. which is slightly below the normal body temperature of 98.6° F. The crystals melting below body temperature allows the flavor receptors of the tongue to be quickly coated with the other ingredients found in chocolate such as sugar, cocoa powder, milk solids, spices and flavorings. The problem is cocoa butter is a polymorphic fat. Polymorphic for cocoa butter simply means that the cocoa butter can be solidified in up to six different crystalline forms. However, only one form—known as beta—gives the desired gloss, snap, mouth melt, and contraction found in high end chocolate confections. The other forms lead to the chocolate being soft, lacking gloss, and even not releasing from molds. These undesirable crystalline forms are known as alpha, gamma, and beta prime.

The cocoa butter in chocolate can be pre-crystalized to solidify in the beta form by either beta crystal nucleation or beta crystal addition. Beta crystal nucleation is accomplished by shearing chocolate at a temperature around 79° F. which forms crystal nuclei of the alpha, gamma, and beta prime types. The chocolate's temperature is then raised to a temperature greater than 85° F. to cause unwanted forms to either melt out or be transformed to beta nuclei. That temperature range is between 86° F. and 91° F. but varies for each formulation. Beta crystal addition is accomplished by adding beta crystals from previously solidified tempered chocolate at a temperature between 86° F. and 91° F. which causes only the beta form of crystals to remain. Only 2 to 3% of beta crystals are required to cause a transformation of alpha, gamma, and beta prime crystals into a sufficient number of beta upon solidification to achieve contraction enough for the chocolate to release from the mold with an excellent gloss and texture.

Batch and continuous are the two general types of tempering methods available. There are many variations as to how each method achieves its goal of developing and maintaining the proper number of beta crystals. In a continuous system, beta crystals are formed using the nucleation method mentioned in the last paragraph to provide tempered chocolate for the project, however, any unused chocolate is than reheated to above 100° F. to melt out all crystals. The chocolate is then cooled to a temperature around 79° F. and then nucleated again. This melting and tempering process continuously cycles all unused chocolate and thus the chocolate always retains the correct amount of beta crystals for good finish product characteristics and flow properties. In a batch system the beta crystal nucleation method can be a nucleation, seed addition, or combination of both. The chocolate is kept at proper thickness for use by adding heat to melt out some of the crystals, but without staying at that temperature for a long enough time to melt out the entire amount of beta crystals. Because beta crystals continue to grow in size and number once formed a batch type of system must be constantly monitored and heated when necessary to melt out some of the beta crystals to ensure the chocolate has the correct flow characteristics.

The issue with crystal nucleation as mentioned above is that once it is started the crystals continue to grow both in number and size causing the chocolate to thicken over time. To control this thickening a tempered chocolate needs precise temperature control to hold the chocolate at a temperature that maintains the minimal number of beta crystals needed for proper contraction, final product gloss, and texture on solidification. In both artisanal and manufacturing situations this is accomplished by holding chocolate in its tempering machine and then using it within five to ten minutes of its removal from the tempering unit or applying heat with agitation to the chocolate to raise the chocolate temperature until a sufficient number of beta crystals are melted to reduce the thickness of the chocolate to a useable consistency.

Therefore what is needed is one machine for each type of chocolate used and an experienced operator to monitor the thickness of the chocolate and apply the precise amount of heat to the chocolate without melting out so many beta crystals that the chocolate transforms into alpha and gamma crystal upon solidification.

### SUMMARY OF THE INVENTION

The present invention is a heat sink base work station designed to maintain the temperature of chocolate above 85° F. for up to 60 minutes and within 1° F. degree of its temperature at removal from the tempering equipment for 15 minutes. The heat sink is designed to hold up to four types of chocolate at a time in a useable tempered state by providing a homogenous temperature environment for the bowl base. In conjunction with the heated bowl base, a cover is provided to prevent the contact of the chocolate's surface with the 70° F. to 80° F. room air when the chocolate is not being used. This allows white, milk, and dark chocolates which have different final tempering temperatures to be housed in the same heat sink.

The heat sink has been designed to provide a 90.5% more energy efficient unit over that of using four 1.5 pound batch table top tempering units. These table top tempering systems use 400 watts to keep chocolate in temper. If four types of chocolate are held at temperature that would require 1600 watts. The present invention requires only 150 watts to hold four chocolates in temper or just 9.5% of the four-unit system. The Inventors achieved this by designing the system to use just one fan, two 55 watt heat lamps, and no electrical agitation system. This could not be accomplished if the Inventors used a method that merely heated the chocolate because the heat would cause hot spots due to unequal heating of non-spinning pots/bowls.

In addition, heating the air to a specific temperature helps prevent hot spots which would cause the loss of temper in the small amounts of chocolate that are left on the bottom of the bowl at the end of an experience. This provides the maximum amount of tempered chocolate to be available to the client.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIGS. 1-4 are planer views of the countertop surfaces and internal components of the workstation of the present invention;

FIGS. 4-8 are planer side view of the end, front, customer, and employee sides of the workstation of the present invention;

FIG. 9 illustrates a side view of an end and countertop surface of the workstation of the present invention;

FIGS. 10-11 are planer views illustrating the internal drawer and other components of the workstation of the present invention;

FIGS. 12-17 illustrate internal, heat sink construction of the workstation of the present invention; and

FIGS. 18-23 illustrate all planer views of the heat sink top of the workstation of the present invention.

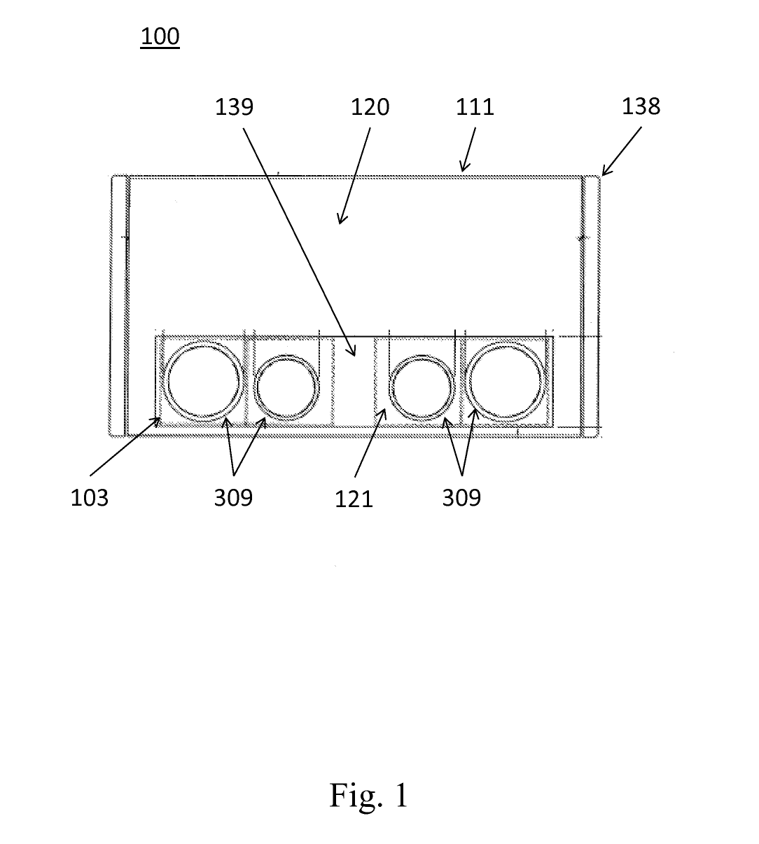

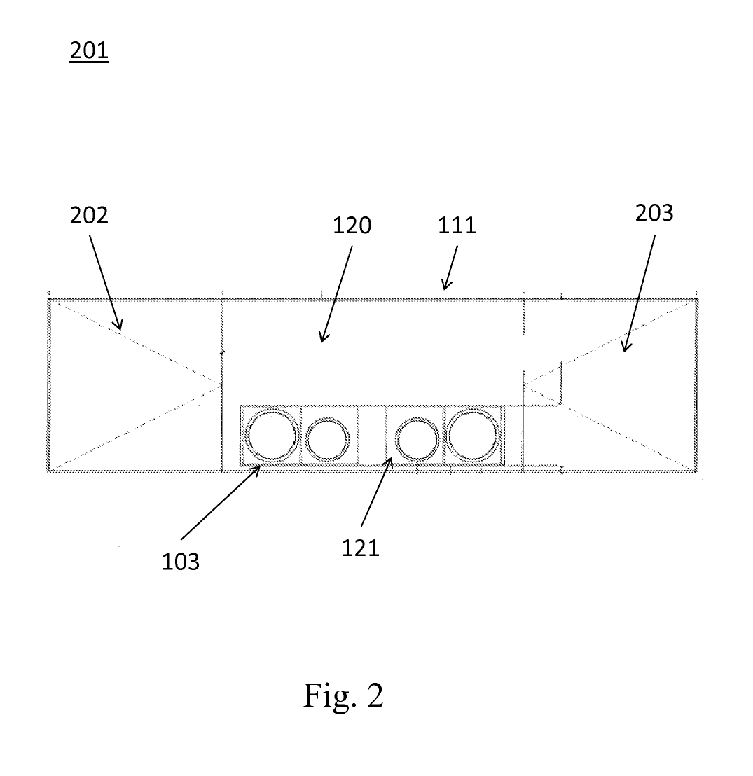

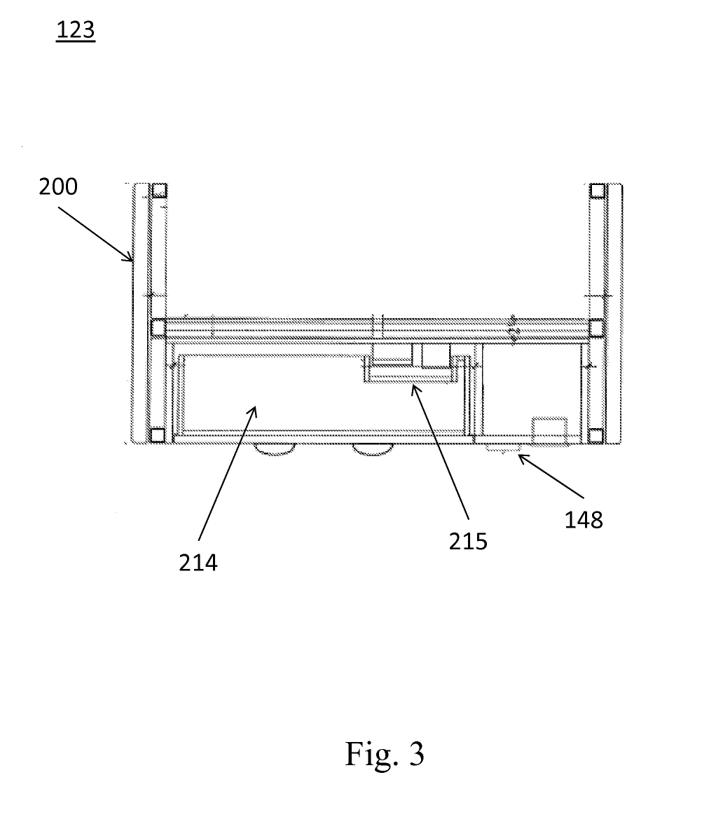

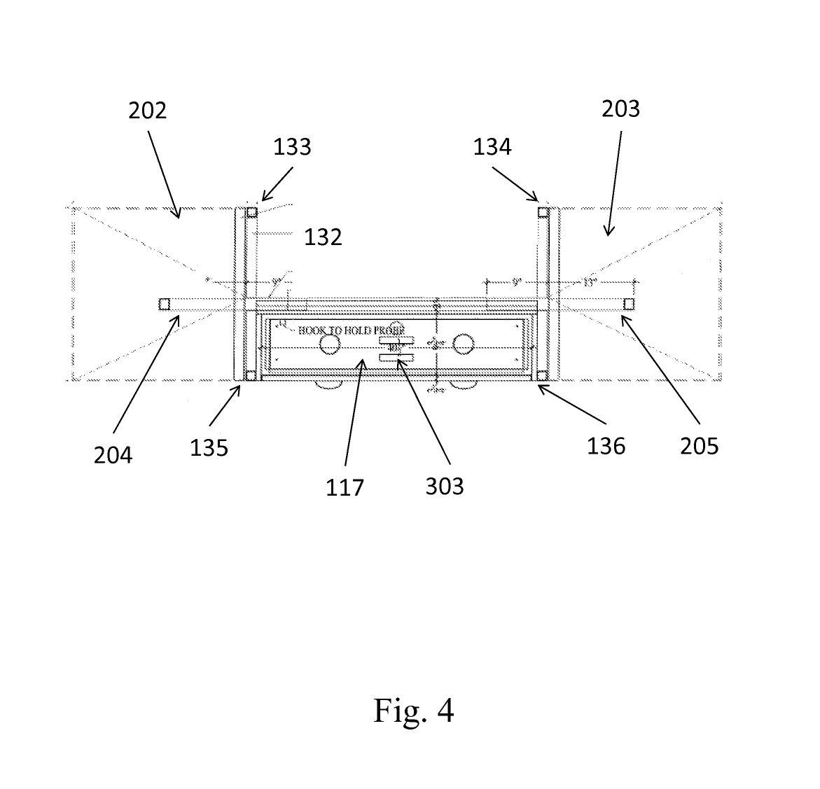

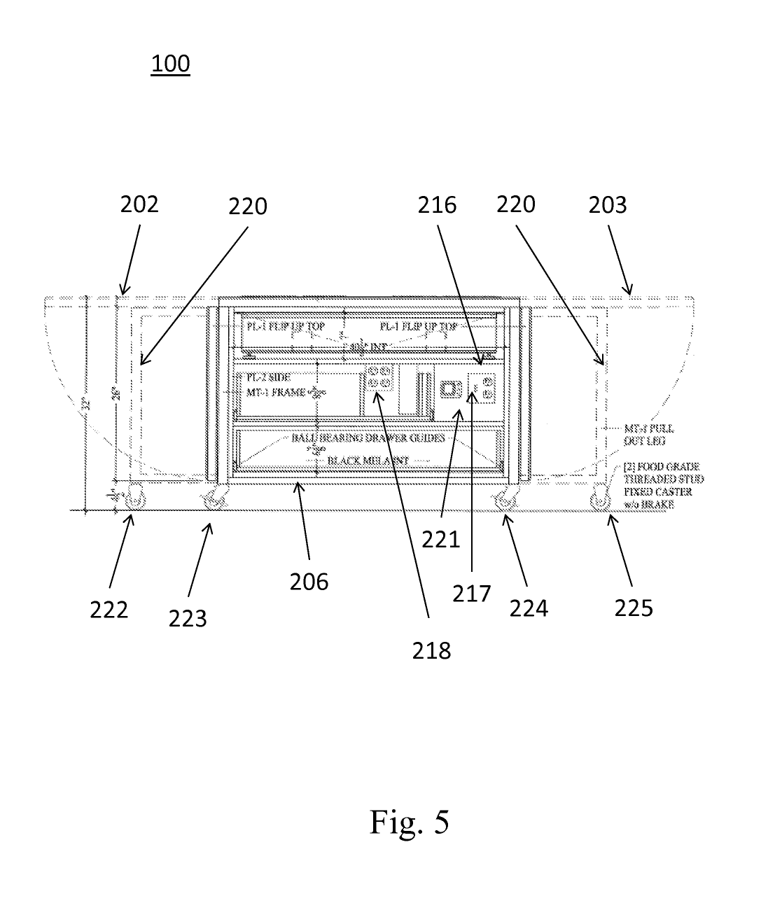

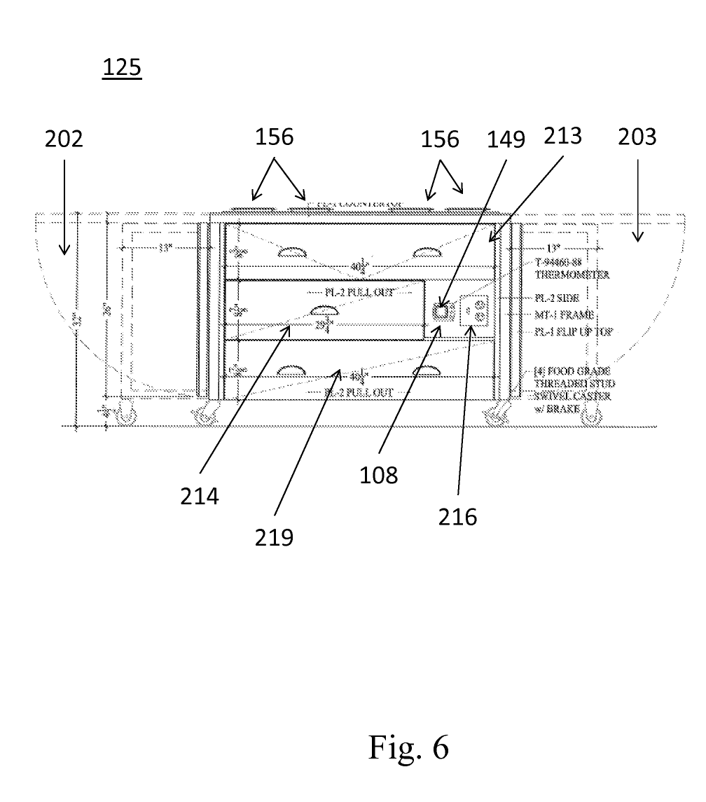

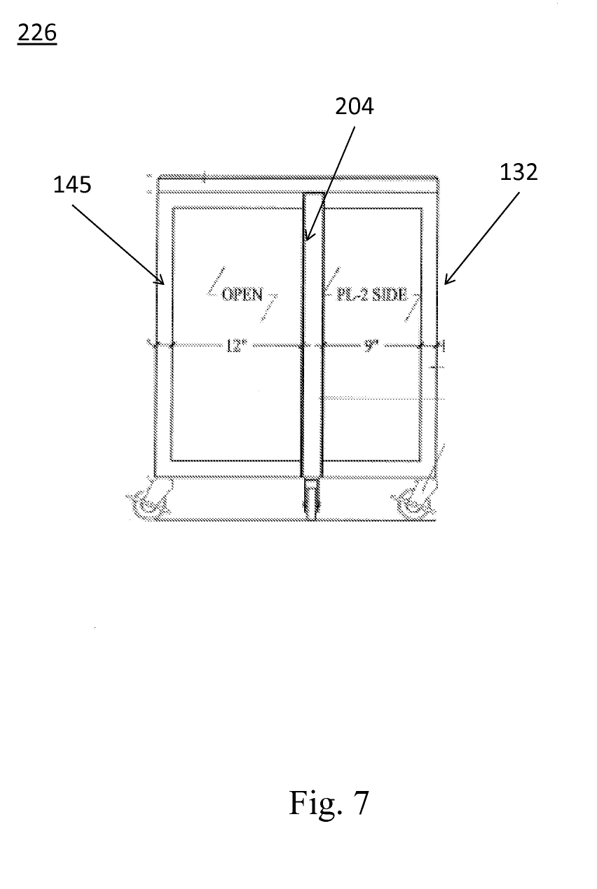

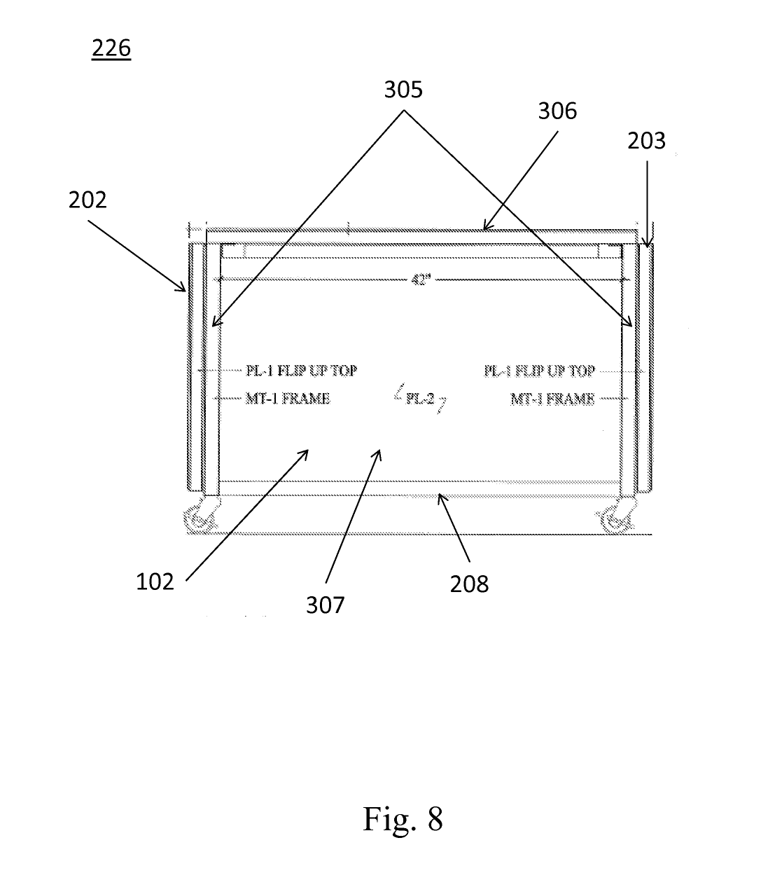

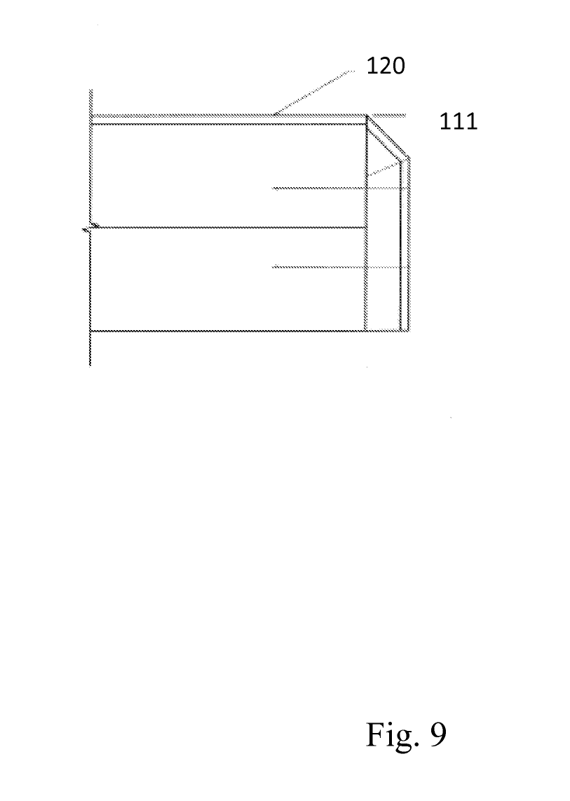

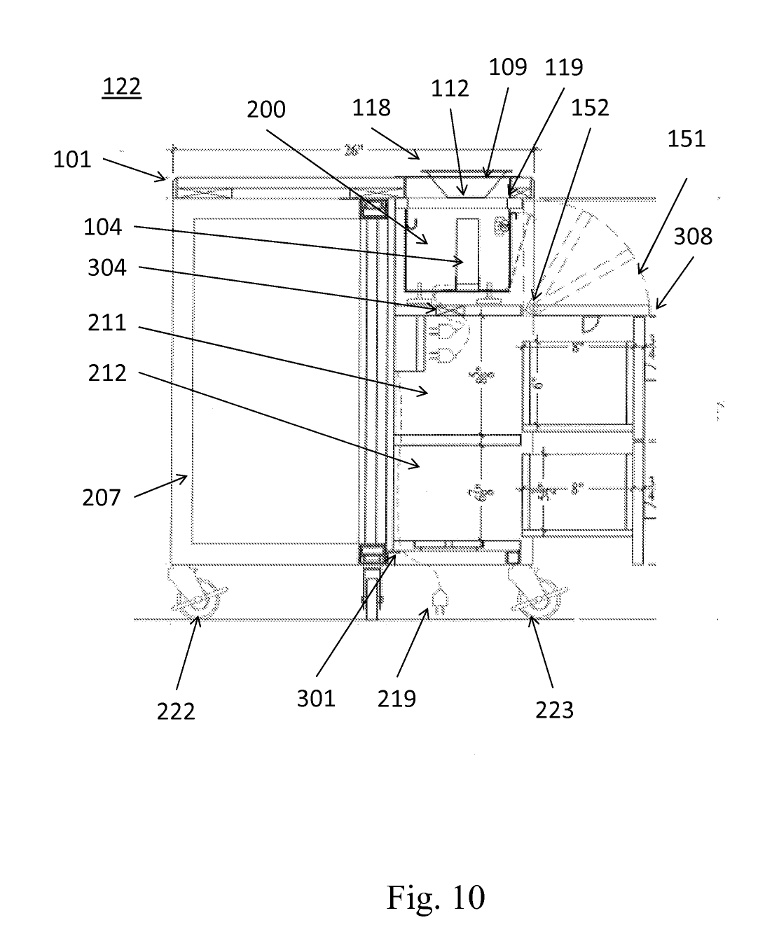

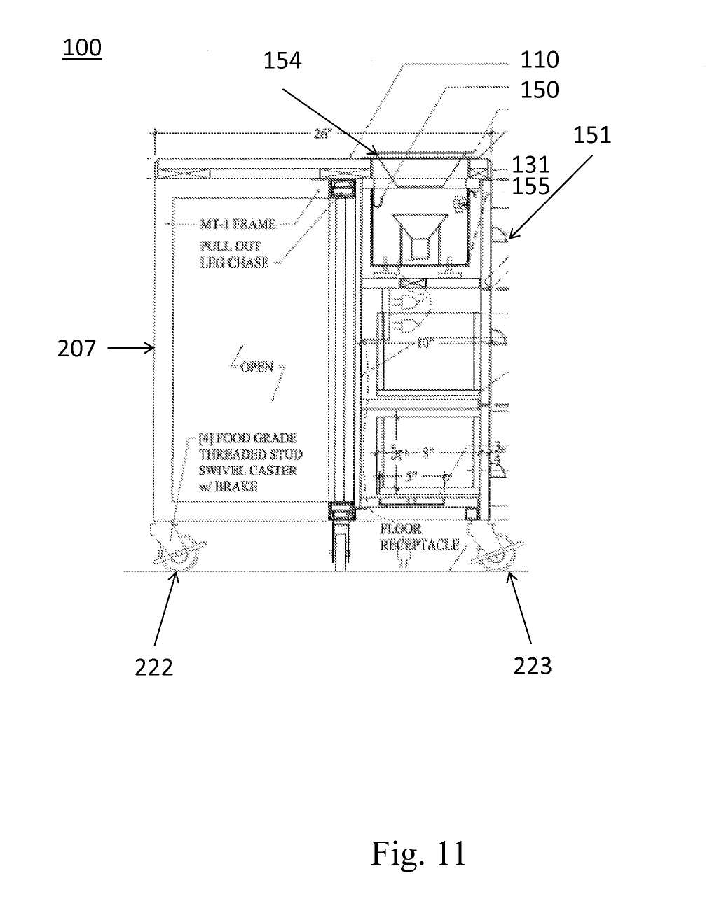

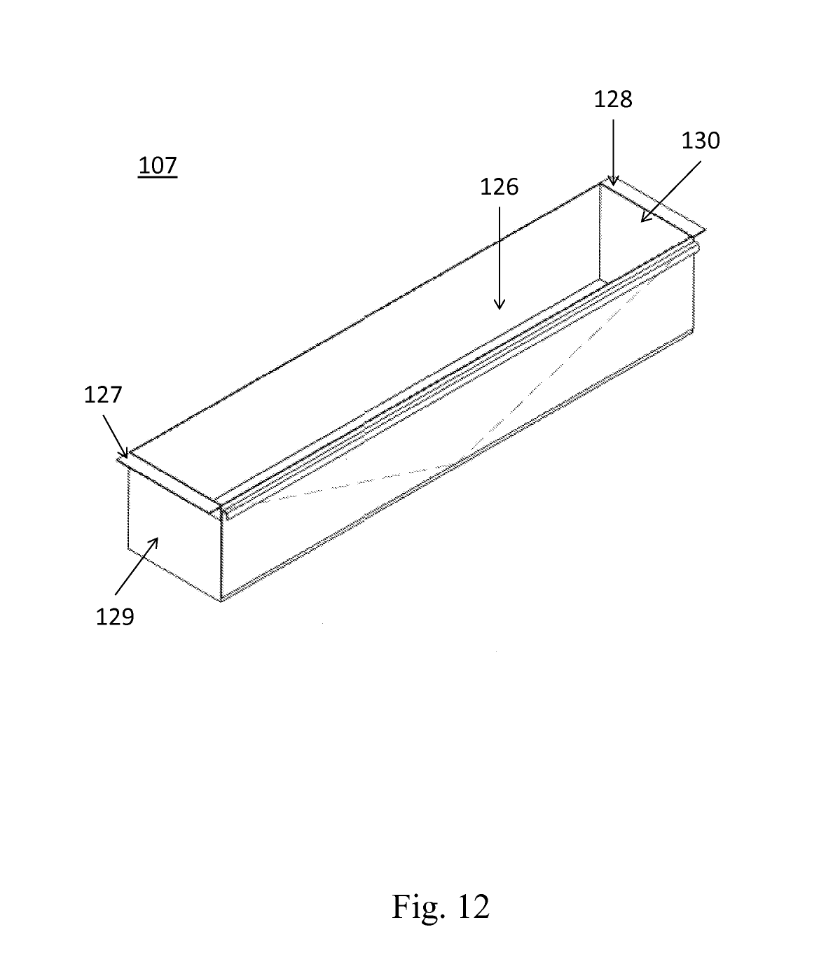

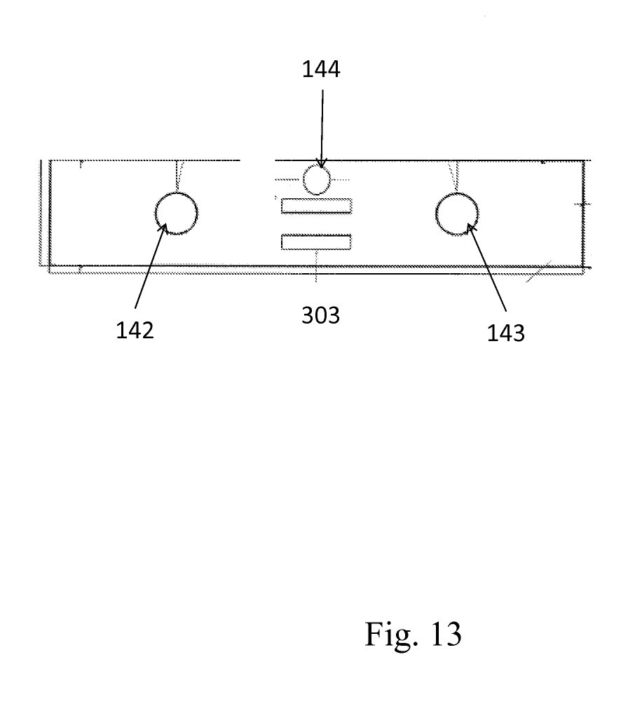

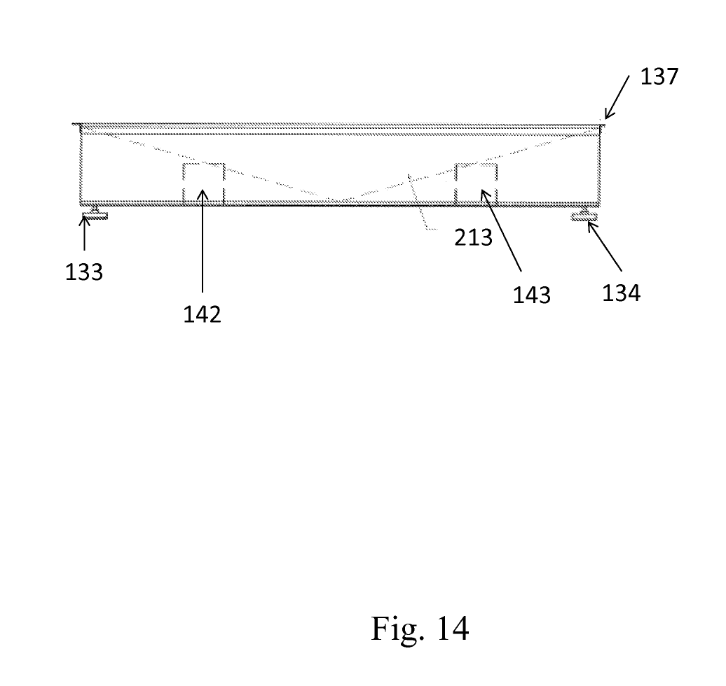

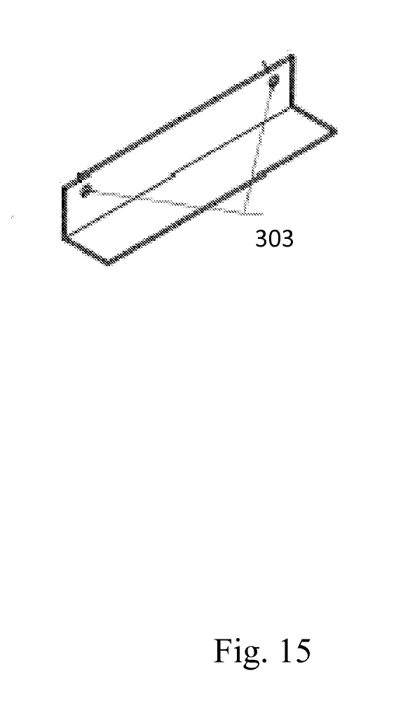

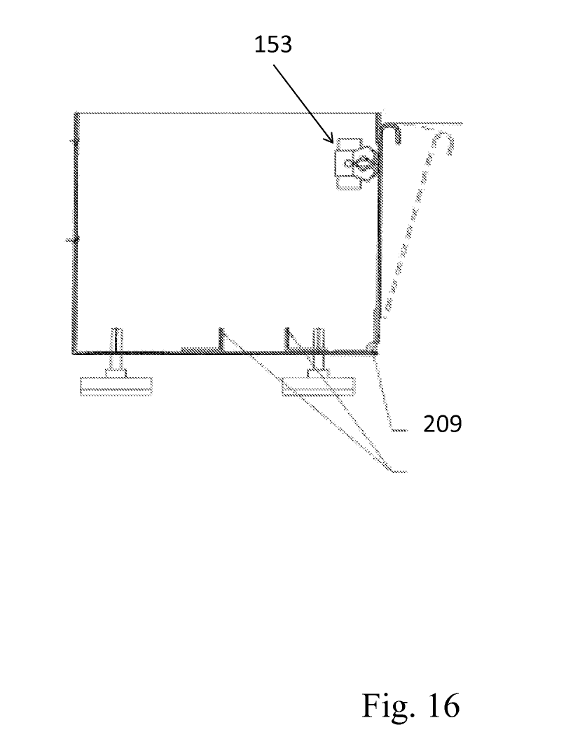

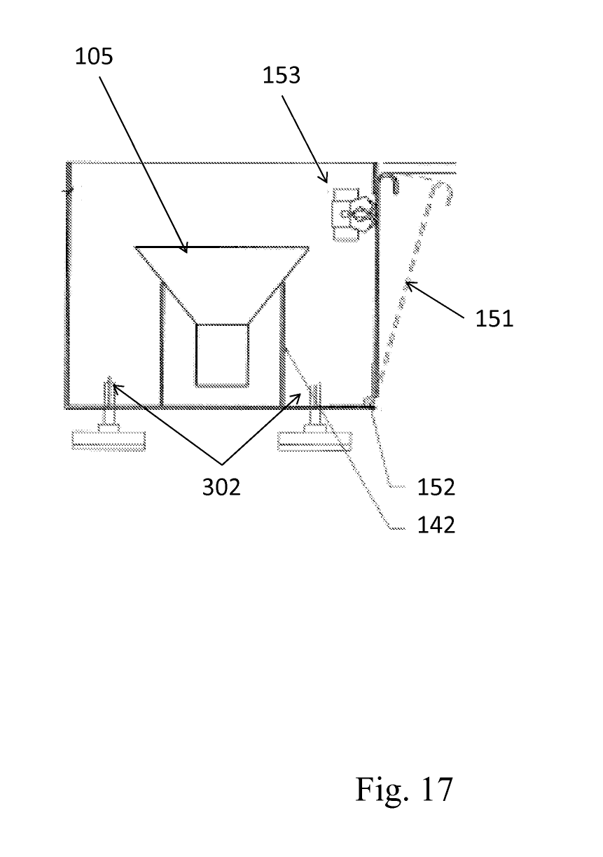

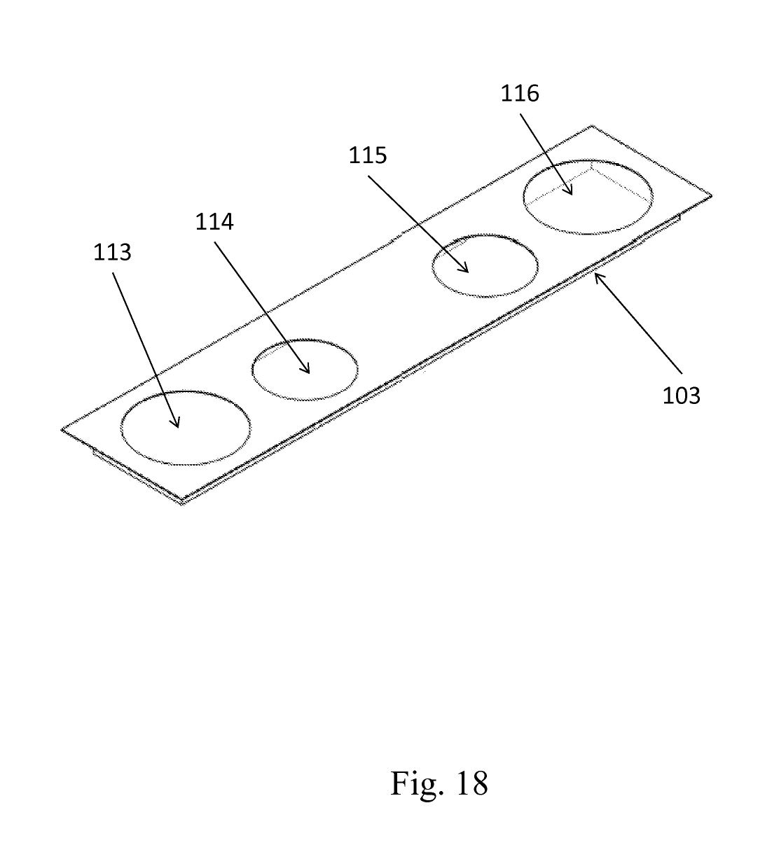

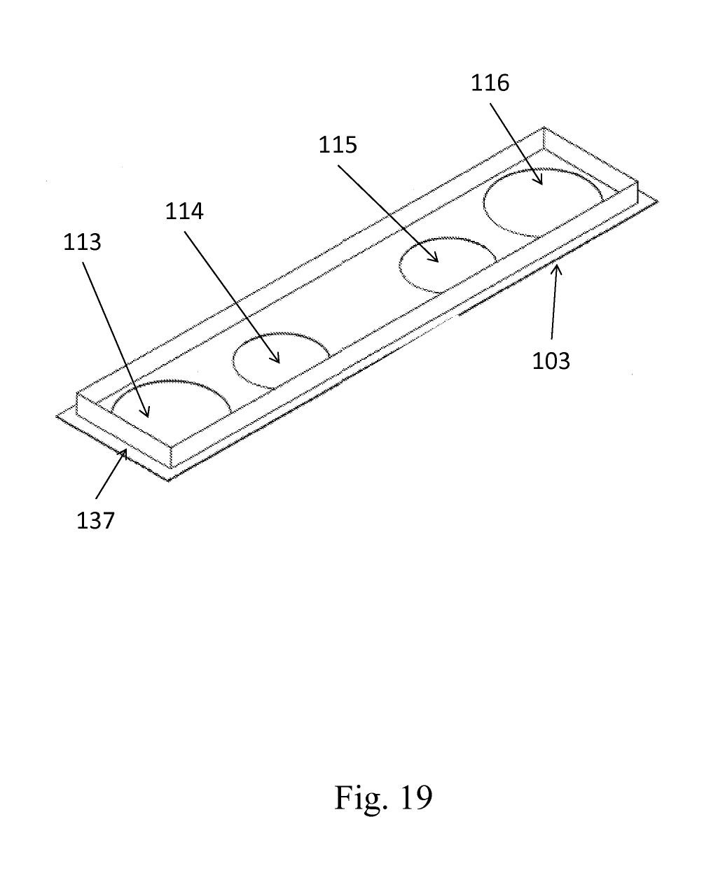

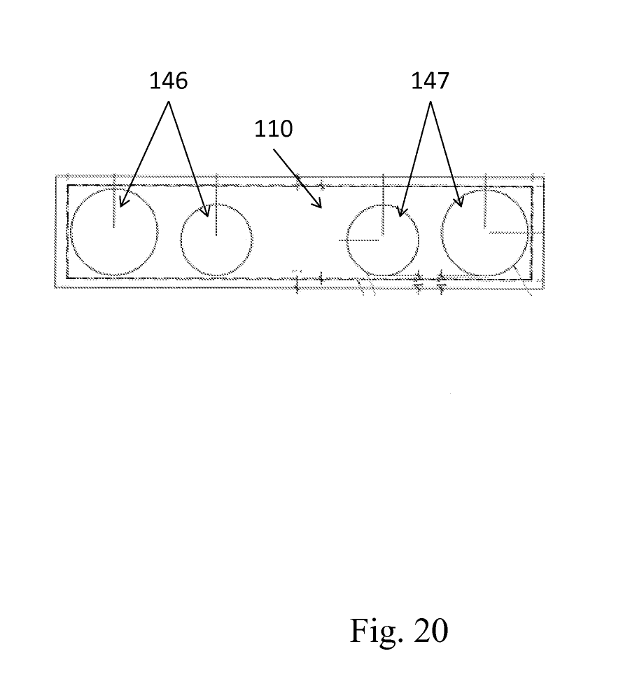

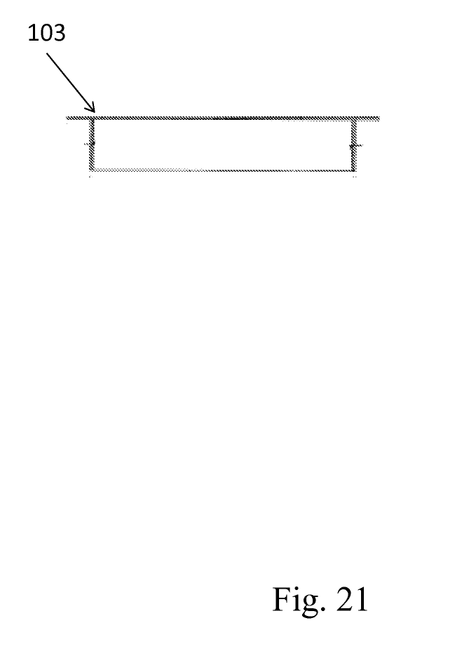

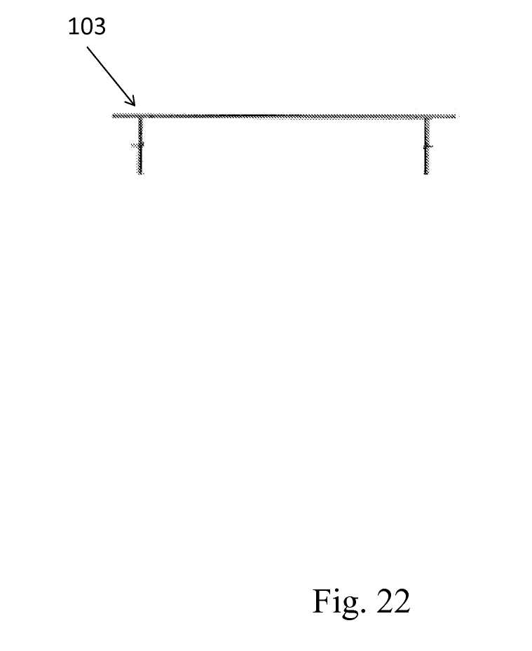

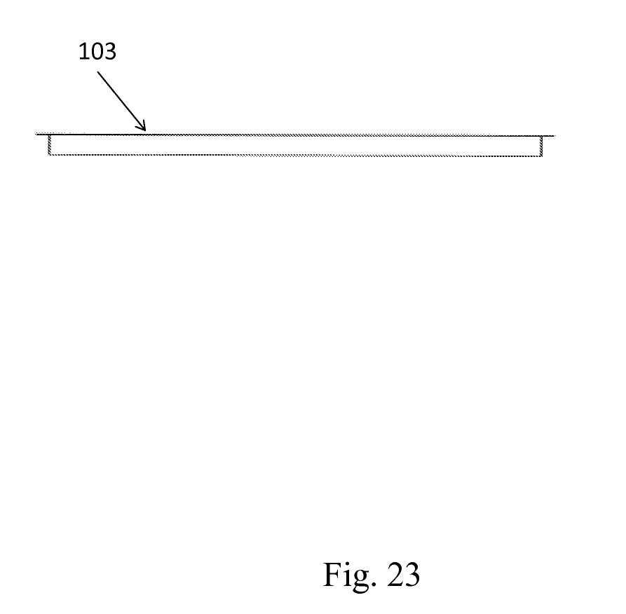

### DETAILED DESCRIPTION OF THE INVENTION

In the following detailed description of the invention or exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

In a best mode of operation, the present invention is designed specifically for use by unskilled retail customers to be able to come off the street and, within minutes of walking in an entertainment cooking environment, be able to make professional-quality artisanal chocolates in a pleasant and comfortable retail environment, not kitchen or factory setting.

The Inventors wanted to offer customers an opportunity to work with up to 400 grams each of up to four different tempered chocolate formulations at the same time. They also wanted to give them a time frame to work with their chocolate of between 10 and 60 minutes in a room environment ranging from 70° F. to 80° F. Also, they did not want to be intruding into their experience with a heat gun to warm up their chocolate. Finally they wanted to present the tempered chocolate in a readily accessible, tip resistant container so they would be in control of their experience.

Now referring to Figures, the embodiment of the present invention is shown. The present invention is a heat sink base work station 100 designed to maintain the temperature of chocolate above 85° F. for up to 60 minutes and within 1° F. degree of its temperature at removal from the tempering equipment for 15 minutes. The heat sink 101 is designed to hold up to four types of chocolate at a time in a useable tempered state by providing a homogenous temperature environment for the bowl base 102. In conjunction with the heated base 107, a cover 103 is provided to prevent the contact of the chocolate's surface with the 70° F. to 80° F. room air when the chocolate is not being used. This allows white, milk, and dark chocolates which have different final tempering temperatures to be housed in the same heat sink.

The Inventors discovered that by keeping the temperature of the heat sink 101 above the temperature at which alpha and gamma crystals rapidly form, it can prevent rapid crystal formation in a wide variety of chocolate formulations in the same heat sink 101. The ideal temperature setting for this sink is 87° F. if it were to hold white, milk, and dark chocolates. However, a temperature range of 86° F. to 90° F. may be selected according to the range of chocolate temperatures at time of removal from the tempering unit 108.

In order to minimize the loss of heat when a bowl 109 is set on the work surface, the work surface is prepared of a low thermal conductivity material 110. This also allows one to use hand agitation by a spatula instead of a heated and enclosed motorized agitation system.

To handle giving the client easy access to the four different types of chocolate, the Inventors created an easily accessible but tip resistance bowl 107 by using a round bowl 107 with beveled sides 111 and a flat bottom 112. Each bowl 113, 114, 115, and 116 rests in a round hole 113, 114, 115, and 116 created in the top plate 117 of the heat sink 101. The bevel sides 111 allows the bowl flange 118 to be elevated above the heat sink 101 top by making the hole slightly smaller than the diameter of the bowl at the point where the bowl cavity 119 joins the bowl flange 118. This provides for easy gripping and thus removal and replacement of the bowl 107 in the heat sink 101. The flat bottom 112 and low height to width ratio provides a low center of gravity and flat resting platform at the contact point between the bowl 107 and countertop surface 120. This makes for a very stable bowl 107 whether resting in the heat sink receptacle/holes 113, 114, 115, and 116 or sitting on the countertop surface 120 during use. The rounded bowl 107 also provides for no 90 degree corners and thus for maximum ease in both stirring and removal of the chocolate.

In order to achieve the largest countertop surface 120 we designed a 8⅝″ by 8⅝″ by 1″ square plastic cover 121 instead of a round cover. The square covers align squarely against each other providing an additional 128 square inches of work surface if only one chocolate is being used.

The heat sink 101 has also been designed to provide a 90.5% more energy efficient unit over that of a using four 1.5 pound batch table top tempering units. These table top tempering systems use 400 watts to keep a chocolate in temper. If four types of chocolate are held at temperature that would require 1600 watts. The system of the present invention requires only 150 watts to hold four chocolates in temper or just 9.5% of the four unit system. The Inventors achieved this by designing the system to use just one fan 104, two 55 watt heat lamps 105 and 106, and no electrical agitation system. This could not be accomplished if one used a method that simply heated the chocolate directly because the heat would cause hot spots due to unequal heating of non-spinning pots/bowls.

In addition, heating the air to a specific temperature helps prevents hot spots which would cause the loss of temper in the small amounts of chocolate that are left on the bottom of the bowl at the end of an experience. This provides the maximum amount of tempered chocolate to be available to the client.

The modular design of the heat sink 101 allows it to be placed into a variety of cabinet styles. In one embodiment of the present invention, a workstation 122 can seat up to four people, working with up to four different chocolate formulations. The heat sink base 123 is an insulated stainless steel box 124 containing two 55 watt heat lamps 105 and 106. The heat sink 101 is held in place in the top chamber 126 by two L shaped lips 127 and 128 mounted at the top of each narrow end 129 and 130 of the heat sink 101. The heat sink 101 is slid into these channels and aligned with the holes 113, 114, 115, and 116 in the countertop 120. A rubber gasket 131 is placed around the holes 113, 114, 115, and 116 in the countertop 120. The L frame 132 is welded on the bottom of the heat sink top at it is passed through the gasket and down into the heat sink base. Four leveling legs 133, 134, 135, and 136 are then used to press the bases L channel 137 up into the top of the C channel 138 creating a friction connection which holds the heat sink 101 in place.

One heat lamp 105 is centered in the gap 139 between each end set of two bowls 140 and 141. The lamp fixtures 142 and 143 are held in place by a 3″ diameter by 3″ long piece of pipe 144. This positions the lamps 105 and 106 about 2″ below the bottom of the bowls. This alignment means the bowls receive a minimum amount of direct heat. A 55 CFM fan 104 is mounted between the center two bowls 114 and 115 and in line with the heat lamps 105 and 106 to circulate the heated air within the box 145. Two sets of holes 146 and 147 are provided at each end of the heat sink top. Each set of holes is sized to support both a 5¾″ bowl and a 7″ bowl. Each hole 113, 114, 115, and 116 is sized so each bowl flange 118 is kept between ¼″ and ½″ off the top of the heat sink 101 by the bevel sides 111 of the bowl 107.

A thermostat temperature control box 148 controls both 55 watt heat lamps 105 and 106 to a precision of plus or minus 1° F. A temperature readout 149 with a precision of plus or minus 0.5° F. is provided to ensure the accuracy of the temperature controller and allows an easy to read means of ensuring that the controller is set to the correct temperature. Both the readout 149 and controller probes 150 are mounted within an inch of the bottom side of the heat sink top 101 and an inch away from the corner of the left back wall and left side wall. This position ensures the heat is circulated homogenously throughout the sink.

A tip-out door 151 is connected to the heat sink 101 by a weld-in-place piano hinge 152 and held in place by press-in or magnetic door clasps 153. A plastic rim liner 154 is used to cover the exposed edge of each bowl receptacle hole 113, 114, 115, and 116 in order to prevent unwanted scraping and noise when the bowl is removed. A rubber flange gasket 155 is supplied to prevent chocolate from collecting between the flake board covered laminate cabinet top surface 120 and the bottom of the stainless steel heat sink top 101. An 8⅝ by 8⅝ inch by 1″ high plastic cover 156 for each bowl 107 is used to prevent the cooling of the chocolate by the room air and as a means of expanding the work surface.

The cabinet 200 is made out of ¾″ flake board covered with a laminate. The base cabinet table top 201 is 27″ deep and 45″ long and stands 32″ high. The table contains a flip up worktop at each 202 and 203 end that is 27″ wide and 26″ long. Without the flip up tops the usable counter surface area is 1170 square inches. Each end leaf 202 and 203 provides a usable surface area of 702 square inches for a total work surface of 2574 square inches. Each leaf 202 and 203 is supported by a wheeled pullout leg 204 and 205. The top and bottom brace 206 is channeled through a chase 207 mounted to the outside back wall of the unit at the top and the bottom 208. Each leaf 202 and 203 is connected to the narrow end of the unit using hinges 209. The instructor/drawer side of the cabinet contains 3 compartments 210, 211, and 212.

The top, first compartment 210 is 8⅜″ high by 40¼″ inches long and houses the base of the heat sink 101. An 8⅜″ high by 40 1/42″ tip out door 212 is provided to give access to the sink for cleaning and repairs.

The next lower, second compartment 211 houses a 6″ high by 29¼″ long by 8″ deep drawer 214 with a 2″ deep by 10″ long cut out 215 in the back right corner to allow for the mounting of a quad electrical receptacle and the temperature controller on the inside wall. The other 10¼″ front wall of this compartment holds a duplex electrical receptacle 216, thermometer readout 149, and a lighted rocker switch 217. A 2″ hole 218 is provided in the back floor of each compartment 210, 211, and 212 to provide a chase way for the main power cord 219 to connect to the rocker switch 217. Both the quad receptacle 218 and the duplex receptacle 216 are wired to be controlled by the lighted rocker switch.

The third compartment 212 holds a 5½″ high by 40″ long by 8″ deep drawer 219. The top and bottom drawers 214 and 219 each have two handles equally spaced approximately 10″ in from each end of the drawer. The center drawer 214 has one handle placed in the center of the drawer front. The client side of the pod is 14½″ from the outer edge to the outside back wall of the heat sink cabinet. A wheeled C shape leg 220, open in the center supports the client side portion of the countertop at each end. The unit also contains a duplex receptacle box 216 mounted in the permanent front panel 221 adjacent to the drawer 214 directly below the heat sink 101. Each pod cabinet 226 has 1 locking wheel 222, 223, 224, and 225 mounted at each of the 4 corners on the bottom of the pod 206.

To use the present invention, the pod 206 is turned on thirty minutes prior to use to allow the heat sink 101 to equilibrate to a set temperature of 87° F., or the controller 148 is set to another temperature determined by the lowest chocolate temperature at the time the chocolate would be removed from the tempering unit. Due to variations in how easily a formulation tempers due to its' cocoa butter to milk fat ratio, this temperature can only be determined by matching the temperature of the chocolate at time of removal from the pod to the rheology requirements of the product to be produced by the chocolate. Details of setting the controller temperature 148 are outlined in the controller instructions. The chocolate is tempered to the desired thickness for proper flow for the projects being completed.

Next, empty bowls 107 are placed in the pod 206 and covered with the plastic lids 121 and the worktable is ready for use. Up to 340 grams (12 oz) of chocolate are poured into the appropriate pod bowl: 6.5″ for dipping and 7″ for pouring. The lids 121 are occasionally removed at 5 to 10 minute intervals and the chocolate is stirred with a spatula. The bowl 107 is removed and the chocolate is stirred with a spatula prior to using. Items are then dipped into the chocolate or the chocolate is used to fill molds. The bowl 107 is then placed back into the receptacle 113, 114, 115, and 116 and covered by the lid 121 for maintenance of the proper chocolate thickness. If the chocolate should become too thick a heat gun is used to warm up the chocolate until the desired thickness is achieved. Once all the chocolate is removed from the bowl 107, the bowl 107 is washed, dried, and placed back in the bowl supply area.

The worktable of the present invention is physically comprised of a Heat Sink Base 101. The stainless steel for the box is measured and cut to the appropriate size for the number of pod holes 113, 114, 115, and 116 to be incorporated. The entrance hole 301 for the thermostat cable and the temperature readout cable is drilled and the edge of the hole is smoothed. Holes 302 are drilled and threaded for the adjustable legs. A 2″ hole 303 is drilled in the center of the base 102 towards the back side of where the fan 104 will be mounted to provide a raceway 304 for the plugs for the heat lamps 105 and 106 and fan 104. The base material is slotted for the forming of the box walls.

The box walls 305 are bent 90 degrees to an upright position. The slots are welded shut the complete length of the cut to maintain heat. The top cross beam 306 connecting the walls 305 that enclose the door is cut and welded into place. The door 307 is cut to size; a J channel 308 is formed on the top edge of the tip out door 307 for ease of opening. A piano hinge 152 is welded on the bottom edge of the door 307. The piano hinge 152 mounted to the door 307 is welded in place on the sink's base. The door clasps are welded into place on both the door panel and the side walls. The fan mount is welded in place.

A 1.5″ by 1.5″ channel support lip is welded onto the top at each end of the narrow end of the heat sink box. A 3″ diameter by 3″ long piece of pipe is notched for entrance of the heat lamp wire and then welded in place with the notch down. The light fixture cord is run through the notch in the bottom of the pipe and the lamp is supported by the pipe. The fan is mounted in place in the center of the box according to drawings and the cord is run through the box wall hole.

The heat sink's top is cut to size. The appropriate size holes are made in the top piece according the schematic. Each hole 113, 114, 115, and 116 is sized to allow for a ¼″ to ½″ gap between the top and the bottom of the bowl flange. A plastic liner 309 is placed around the edge of each hole to prevent noise when the bowl is moved. A 1½″ by 1½″ by 1/16″ angle stainless steel is welded in place on the bottom of the heat sink top plate to form a rectangle frame 11/16″ in from the outer edge.

The Cabinet is constructed from flake board laminate using general cabinet construction methods and procedures and in accordance to the dimensions stated on the drawing. All wood pieces cut to the size defined in the drawing and laminated. The top and bottom raceways are cut into both end pieces and the exposed flake board edges are laminated. Dowel holes are drilled in all pieces. A 2″ hole is drilled through the floor piece that will go between the heat sink chamber and the drawer containing the electrical outlet and thermostat control. A 2″ hole is drilled into the floor at the back of each drawer divider as a raceway for the power cord. The cabinet's side walls and chamber dividers are dowelled and glued together. The flip top hinge is mounted onto the outside wall and then the top is attached to the hinge. The pullout leg top, bottom, and end pieces are drilled for dowels and then dowelled, glued, and clamped until the glue is dried. A wheel is attached to the bottom of each leg.

The countertop work surface has a hole cut into it slightly larger than the size of the heat sink top drop in frame. The heat sink mounting channel is mounted to the bottom of the countertop at the edge of the narrow end of each side of the hole. The counter top is dowelled and glued in place. The unit is turned upside down and the four wheels are attached to the corners of the base cabinet. The control and outlet chamber drawer is constructed with a 3″ by 6″ step in in the right back corner of the drawer.

The outside part of the ball bearing drawer guides are mounted on the inside of the sidewall. The inside moveable part of the ball bearing drawer guide are mounted on the drawer. The drawer bottom and side walls are constructed. The drawer face is mounted. The hole is cut into the permanent cabinet face for the duplex receptacle. The hole is cut into the permanent cabinet face for the lighted rocker switch. Hinges are mounted on the tip out cover. The tip out cover is mounted to the heat sink chamber floor. Handles are installed on each drawer.

The heat sink electrical and temperature control components are comprised of a quad outlet box mounted on the back wall of the cabinet according to electric code standards. The thermostat is mounted onto the back wall of the second drawer beside the quad receptacle. The quad and duplex receptacle are connected to be controlled by a lighted rocker switch mounted on the front panel of the box. The fan is connected to one of quad receptacle and is always on whenever the unit is powered on by the lighted rocker switch to provide continuous air circulation inside the box. The temperature monitoring probes are directed into the cabinet through a hole, and the temperature monitoring readout is mounted on the front panel.

The heat sink is attached to the cabinet whereby the sink's base is slid into the C channel half way. The thermal couple and temperature monitoring probes are brought into the chamber through a hole in the bottom back wall and are anchored in place in the upper right corner of the back wall of the heat sink. The light cords are directed through the hole in the sink base and the hole in the floor of the sink chamber of the cabinet and connected to the thermostat controller plug through a triplet receptacle adapter. The fan cord is directed through the hole in the sink base and the hole in the floor of the sink chamber of the cabinet and connected to the quad outlet. The sink is pushed into the cabinet until it aligns with the hole in the cabinet top. The leveling feet are raised until the sink is anchored against the top of the cabinet bottom. The rubber gasket is put in place around the hole. The sink top is dropped in from the top.

In an alternative embodiment, a higher conductivity countertop material due to durability and ease of shaping can be made. The material change is this embodiment is from a hard board topped with laminate to a CORIAN style synthetic stone, to allow for the removal of sharp corners. This material is expected to last longer and give smoother edges and lines. When using a synthetic style stone, the present invention will overcome the thermal conductivity issue by adding spacers to the bottom of the project trays in order to have an insulating air gap between the tray and the countertop.

In yet another embodiment, in order to make the countertop height of the pod adaptable for the various ages of clients and various experience types, the Inventors have decided to locate the components in a cabinet mounted on a portable lift table. A commercially available adjustable height table will be used to provide countertop height variations ranging from 28″ to 43″. A facade will be used to hide the legs. An outer façade will track up and down on an inner façade as the table top moves.

In still another alternative embodiment, a version where drinks are able to be served at the pod, while minimizing the possibility of spilling liquids into the heat sink, the top of the sink will be raised 3′ to 4″ to prevent glasses from being tipped over and liquids from flowing into the heat sink. A ground fault interrupter may also be incorporated into this embodiment of the pod. This embodiment incorporates a raised heat sink surface design of 4″ to prevent spilling of drinks into the heat sink while providing a lower countertop work surface height. The lower countertop height is achieved by allowing some of the heat sink to be mounted below the top of the lift table supports.

In another embodiment, two removable pivot shelves can be mounted onto the heat sink top through mounting adaptors welded to the heat sink top. Each individual table will be able to swing from over the bowl holes to over the countertop and will provide a space for toppings, etc. The length and width of the shelves will be determined according to space available.

In another embodiment, two or more pods may be daisy chained together or individually connected to an outlet.

In still another embodiment, the bowl configuration may be changed to five, five inch bowls of various spacing and layout.

In still another embodiment, the drawers are replaced with two shelves. The bottom shelf is formed by the base of the cabinet. The second shelf is placed approximately 7″ above the base shelf. The shelves are notched to allow the electrical cord to reach the floor. The electrical cord is encased in conduit for protection against being cut by items placed on the shelf.

In still another embodiment, one of the bowls is covered with a metal screen frame to allow chocolate when filling a 3-D mold to flow back into the bowl for use later.

In a final embodiment, a removable diffuser placed over the heat sink light bulbs to stop uneven heating of bowls while also preventing chocolate from being dropped onto light bulbs may be incorporated.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A workstation for holding tempered chocolate comprising:
a heat sink holding up to four types of chocolate at a time in a useable tempered state by providing a homogenous temperature environment for a bowl base;
a counter top surface with four holes, each for holding a corresponding bowl;
a rubber gasket is placed around the holes in the countertop;
a heated sink base secured by four leveling legs to the underside of the top surface;
the heat sink base is an insulated stainless steel box, containing two 55 watt heat lamps;
a fan is mounted between the center two bowls and in line with the heat lamps to circulate the heated air within the box;
a thermostat temperature control box controls both heat lamps to a precision of plus or minus 1° F.; and
a cover is provided to prevent the contact of the chocolate's surface with the 70° F. to 80° F. room air when the chocolate is not being used.

2. The device of claim 1, wherein a temperature readout with a precision of plus or minus 0.5° F. is provided to ensure the accuracy of the temperature controller and allows an easy to read means of ensuring that the controller is set to the correct temperature.

3. The device of claim 1, wherein
the countertop holes are arranged as two bowl sets each for holding a corresponding bowl;
one heat lamp is centered in the gap between each end set of two bowls sets about 2 inches below the bottom of the bowls; and
the alignment means the bowls receive a minimum amount of direct heat.

4. The device of claim 1, wherein both the readout and controller probes are mounted within an inch of the bottom side of the heat sink top and an inch away from the corner of the left back wall and left side wall to ensure the heat is circulated homogenously throughout the sink.

5. The device of claim 1, wherein
the two sets of holes are provided at each end of the heat sink top;
each set of holes is sized to support both a 5¾″ bowl and a 7″ bowl; and
each hole is sized so each bowl flange is kept between ¼″ and ½″ off the top of the heat sink by the bevel sides of the bowl.

6. The device of claim 1, wherein
a tip-out door is connected to the heat sink;
a plastic rim liner is used to cover the exposed edge of each bowl receptacle hole;
a rubber flange gasket is supplied to prevent chocolate from collecting between the cabinet top surface and the bottom of the stainless steel heat sink top;
plastic cover for each bowl is used to prevent the cooling of the chocolate by the room air and as a means of expanding the work surface.

7. The device of claim 1, wherein
the cabinet is made out of flake board covered with a laminate;
the table contains a flip up worktop at each end each end leaf is supported by a wheeled pullout leg;
a top and bottom brace is channeled through a chase mounted to the outside back wall of the unit at the top and the bottom;
each leaf is connected to the narrow end of the unit using hinges.

8. The device of claim 1, wherein
the instructor/drawer side of the cabinet contains three compartments;
the top, first compartment houses the base of the heat sink, and a tip out door 212 is provided to give access to the sink for cleaning and repairs;
the next lower, second compartment houses a drawer with cut out in the back right corner to allow for the mounting of a quad electrical receptacle and the temperature controller on the inside wall.
the other front wall of this compartment holds a duplex electrical receptacle, thermometer readout, and a lighted rocker switch;
both the quad receptacle 218 and the duplex receptacle 216 are wired to be controlled by the lighted rocker switch;
the third compartment holds a drawer; and
a hole is provided in the back floor of each compartment to provide a chase way for a main power cord to connect to the rocker switch.

9. The device of claim 1, wherein
a temperature range of 86° F. to 90° F. may be selected according to the range of chocolate temperatures at time of removal from the tempering unit; and
the ideal temperature setting for the sink is 87° F.

10. The device of claim 9, in combination with a tip resistance bowl, the bowl
being round bowl in shape with beveled sides and a flat bottom;
each bowl rests in a round hole created in the top plate 117 of the heat sink;
the bevel sides allows the bowl flange to be elevated above the heat sink top by making the hole slightly smaller than the diameter of the bowl at the point where the bowl cavity joins the bowl flange.

11. A workstation for the iso-thermal, beta crystal stabilization of chocolate comprising:
a heat sink base forming the box walls;
the box walls are bent 90 degrees to an upright position;
slots are welded shut the complete length of the cut to maintain heat;
a top cross beam connecting the walls that encloses the door is cut and welded into place;
the door is cut to size.
a cabinet is constructed from flake board laminate;
a countertop work surface has a hole cut into it slightly larger than the size of the heat sink top drop in frame;
a heat sink mounting channel is mounted to the bottom of the countertop at the edge of the narrow end of each side of the hole;
the counter top is dowelled and glued in place;
the unit is turned upside down and the four wheels are attached to the corners of the base cabinet; and
a control and outlet chamber drawer is constructed with a 3″ by 6″ step in in the right back corner of the drawer.

12. The device of claim 11, wherein the heat sink base is further comprised of
an entrance hole for the thermostat cable and the temperature readout;
holes drilled and threaded for the adjustable legs;
a hole is drilled in the center of the base towards the back side of where the fan will be mounted to provide a raceway for the plugs for the heat lamps and fan; and
the base material is slotted for the forming of the box walls.

13. The device of claim 11, wherein the heat sink base is further comprised of
a J channel formed on the top edge of the tip out door for ease of opening;
a piano hinge welded on the bottom edge of the door;
the piano hinge mounted to the door is welded in place on the sink's base;
one or more door clasps are welded into place on both the door panel and the side walls; and
the fan mount is welded in place.

14. The device of claim 13, wherein the heat sink base is further comprised of
a channel support lip welded onto the top at each end of the narrow end of the heat sink box;
a piece of pipe is notched for entrance of the heat lamp wire and then welded in place with the notch down;
a light fixture cord is run through the notch in the bottom of the pipe and the lamp is supported by the pipe; and
the fan is mounted in place in the center of the box according to drawings and the cord is run through the box wall hole.

15. The device of claim 13, wherein
the heat sink's top is cut to size;
one or more holes are made in the top piece;
each hole is sized to allow for a ¼″ to ½″ gap between the top and the bottom of the bowl flange;
a plastic liner is placed around the edge of each hole to prevent noise when the bowl is moved; and
an angle stainless steel is welded in place on the bottom of the heat sink top plate to form a rectangle frame in from the outer edge.

16. The device of claim 15, wherein the cabinet is further comprised of
top and bottom raceways cut into both end pieces and the exposed flake board edges are laminated;
dowel holes are drilled in all pieces;
a hole is drilled through the floor piece that will go between the heat sink chamber and the drawer containing the electrical outlet and thermostat control;
a hole is drilled into the floor at the back of each drawer divider as a raceway for the power cord;
the cabinet's side walls and chamber dividers are dowelled and glued together;
a flip top hinge is mounted onto the outside wall and then the top is attached to the hinge;
a pullout leg top, bottom, and end pieces are drilled for dowels and then dowelled, glued, and clamped until the glue is dried; and
a wheel is attached to the bottom each leg.

17. The device of claim 16, wherein the cabinet is further comprised of
ball bearing drawer guides are mounted on the inside of the sidewall;
the inside moveable part of the ball bearing drawer guide are mounted on the drawer;
the drawer bottom and side walls are constructed;
the drawer face is mounted;
a hole is cut into the permanent cabinet face for the duplex receptacle;
a hole is cut into the permanent cabinet face for the lighted rocker switch;
hinges are mounted on the tip out cover;
the tip out cover is mounted to the heat sink chamber floor; and
handles are installed on each drawer.

18. The device of claim 11, wherein the heat sink electrical and temperature control components are comprised of
a quad outlet box mounted on the back wall of the cabinet according to electric code standards;
a thermostat is mounted onto the back wall of the second drawer beside the quad receptacle;
a quad and duplex receptacle are connected to be controlled by a lighted rocker switch mounted on the front panel of the box;
the fan is connected to one of quad receptacle and is always on whenever the unit is powered on by the lighted rocker switch to provide continuous air circulation inside the box;
the temperature monitoring probes are directed into the cabinet through a hole; and
the temperature monitoring readout is mounted on the front panel.

19. The device of claim 18, wherein
the heat sink is attached to the cabinet whereby the sink's base is slid into the C channel half way;
the thermal couple and temperature monitoring probes are brought into the chamber through a hole in the bottom back wall and are anchored in place in the upper right corner of the back wall of the heat sink;
the light cords are directed through the hole in the sink base and the hole in the floor of the sink chamber of the cabinet and connected to the thermostat controller plug through a triplet receptacle adapter;
the fan cord is directed through the hole in the sink base and the hole in the floor of the sink chamber of the cabinet and connected to the quad outlet.

20. The device of claim 11, wherein
the heat sink is pushed into the cabinet until it aligns with the hole in the cabinet top;
the leveling feet are raised until the heat sink is anchored against the top of the cabinet bottom;
a rubber gasket is put in place around the hole; and
the heat sink top is dropped in from the top.
